(19) United States
(12) Patent Application Publication
(10) Pub. No.: US 2019/0111849 A1
(43) Pub. Date: Apr. 18, 2019

(54) Open Space Organizer Apparatus and System

(71) Applicant: Matthew Thomas Besley, Carlsbard, CA (US)

(72) Inventor: Matthew Thomas Besley, Carlsbard, CA (US)

(21) Appl. No.: 16/017,989

(22) Filed: Jun. 25, 2018

Related U.S. Application Data
(60) Provisional application No. 62/573,009, filed on Oct. 16, 2017.

(51) Int. Cl. B60R 7/04; B65D 1/36

(52) U.S. Cl. CPC B60R 7/04; B65D 1/36

(57) ABSTRACT

An open space organizer (OSO) apparatus and system that may be configured to be employed in various open storage areas including areas that may include, nest, or be near power sources where the OSO system may include multiple sections.

### BACKGROUND

### 1. Field of the Invention

The invention relates generally to open space organizer apparatus and systems, in particular vehicle console space organizers.

### 2. Description of Related Art

It may be desirable to provide an organizer for open space area having multiple functions. The present invention provides such an apparatus and system.

### BRIEF DESCRIPTION OF THE DRAWINGS

The features, objects, and advantages of the present invention will become more apparent from the detailed description set forth below when taken in conjunction with the drawings in which like reference characters identify correspondingly throughout and wherein:

FIG. 1 is a simplified top diagram of an open space organizer (OSO) system employed in a vehicle console in accordance with an embodiment of the present invention;

FIG. 2A is a simplified isometric diagram of an open space organizer (OSO) system in accordance with an embodiment of the present invention;

FIG. 2B is a simplified top view diagram of an open space organizer (OSO) system in accordance with an embodiment of the present invention;

FIG. 2C is a simplified bottom view diagram of an open space organizer (OSO) system in accordance with an embodiment of the present invention;

FIG. 2D is a simplified right side view diagram of an open space organizer (OSO) system in accordance with an embodiment of the present invention;

FIG. 2E is a simplified left side view diagram of an open space organizer (OSO) system in accordance with an embodiment of the present invention;

FIG. 2F is a simplified front side view diagram of an open space organizer (OSO) system in accordance with an embodiment of the present invention; and

FIG. 2G is a simplified back side view diagram of an open space organizer (OSO) system in accordance with an embodiment of the present invention;

FIG. 3A is a simplified top view diagram of an open storage area in accordance with an embodiment of the present invention; and

FIG. 3B is a simplified isometric diagram of an open storage area in accordance with an embodiment of the present invention.

### DETAILED DESCRIPTION

Throughout this description, embodiments and variations are described for the purpose of illustrating uses and implementations of the invention. The illustrative description should be understood as presenting examples of the invention, rather than as limiting the scope of the invention.

Open storage areas are provided in many products and locations including motor vehicles, boats, commercial and residential structures including console, drawers, cabinets, or other open storage areas. The open storage areas may include, nest, or be near power sources. The present invention provides embodiments of an open space organizer (OSO) apparatus and system that may be configured to be employed in various open storage areas including areas that may include, nest, or be near power sources.

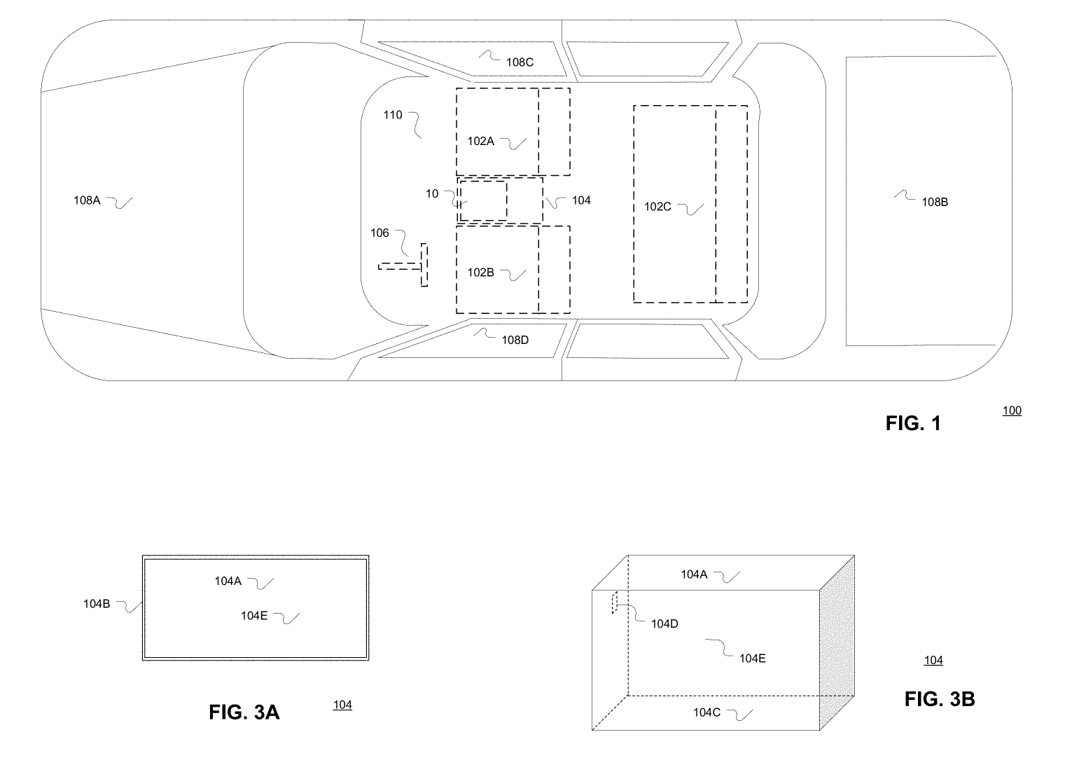

FIG. 1 is a simplified top diagram of an open space organizer (OSO) system 10 employed in a vehicle 100 console 104 in accordance with an embodiment of the present invention. As shown in FIG. 1, a vehicle 100 may include a front section 108A, a rear section 108B, left door(s) 108D, right door(s) 108C and a passenger compartment 110. The passenger compartment 110 may include rear seat(s) 102C, a right seat 102A, a left seat 102B, and a steering wheel 106 on the left or right side. The vehicle 100 passenger compartment 110 may also include an open storage area or console 104. In an embodiment, the console 104 may be located between the front seats 102A, 102B.

FIG. 3A is a simplified top view diagram of an open storage area 104 in accordance with an embodiment of the present invention and FIG. 3B is a simplified isometric diagram of an open storage area 104 in accordance with an embodiment of the present invention. As shown in FIGS. 3A and 3B, an open storage area 104 may have an opening 104A to a bottom 104C. The opening 104A may include borders or a frame 104B in an embodiment. The open storage area 104 central opening 104A may have a known opening dimension(s) and shape. Similarly, its volume and depth shape and dimensions may be known. An OSO system 10 according to various embodiments may be sized and shaped to fit within all or part of a segment of an open storage area 104 including extend beyond a section of the central opening 104A in an embodiment. As shown in FIG. 3B, an open storage area 104 may also include a power interface or conduit 104D on one or more walls within its cavity 104E.

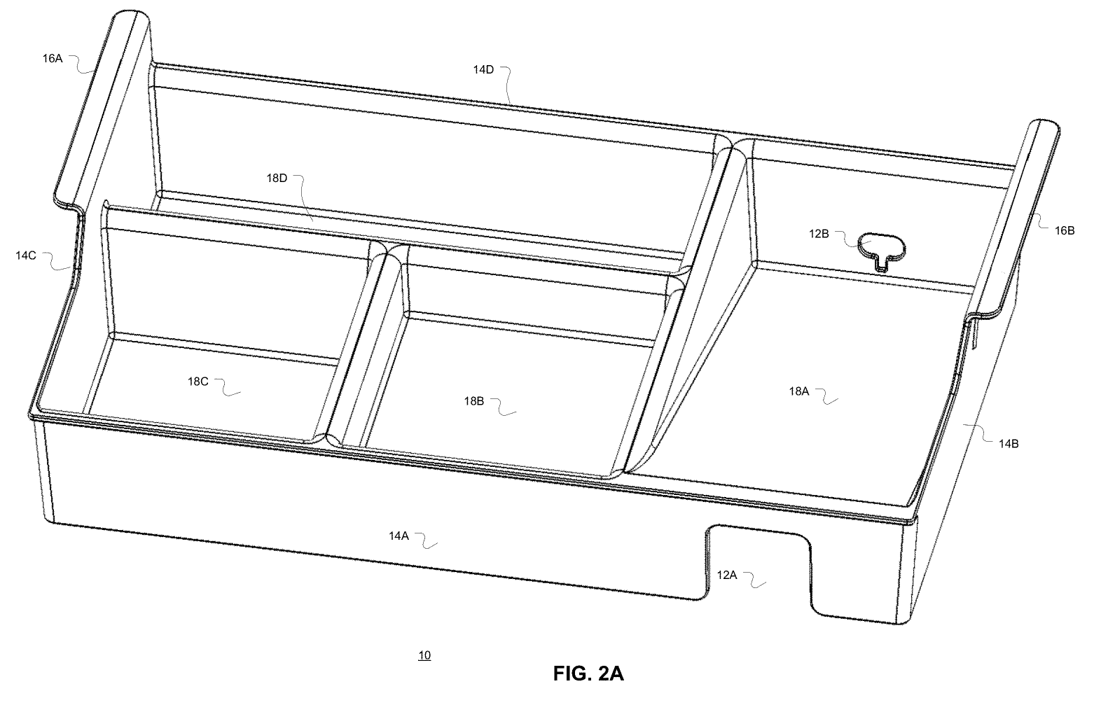

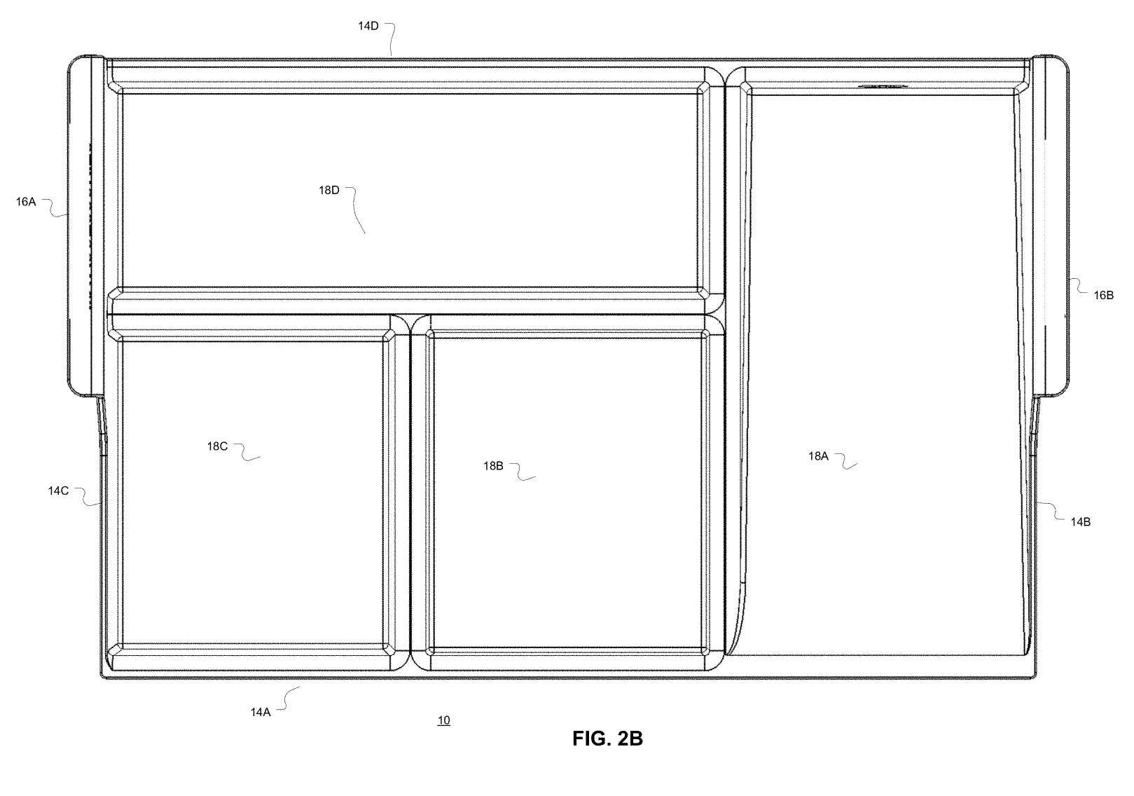

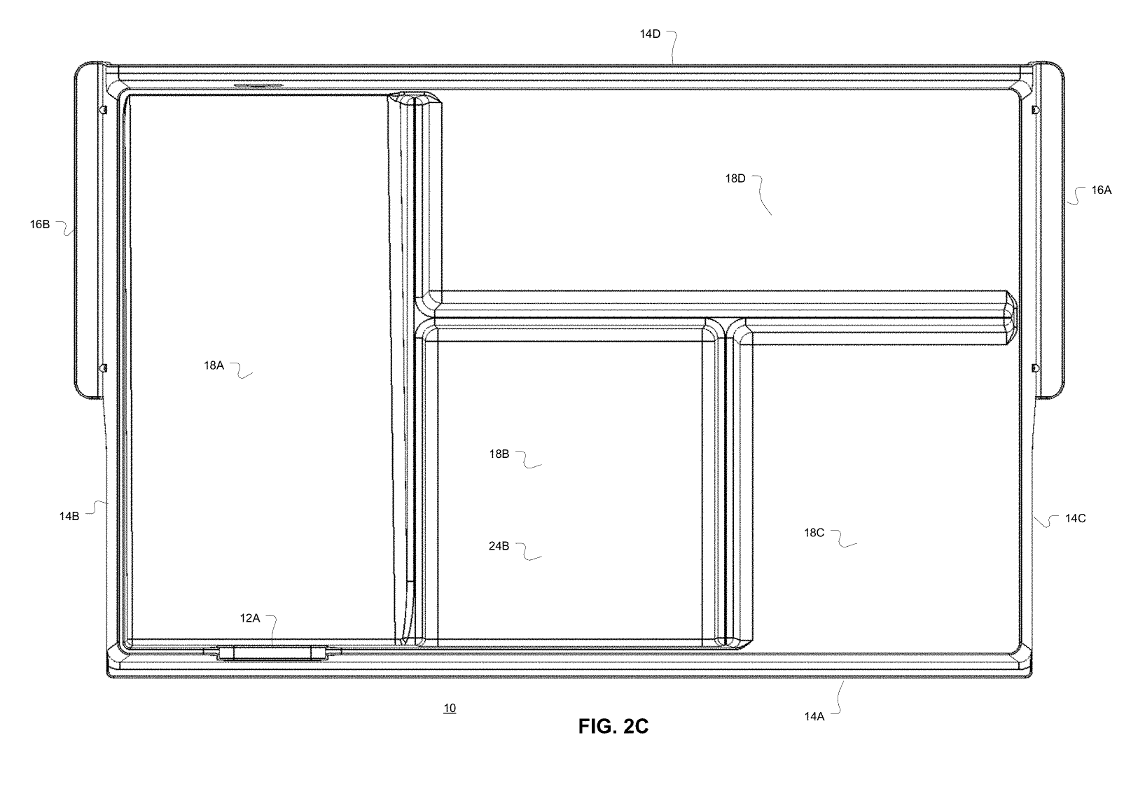

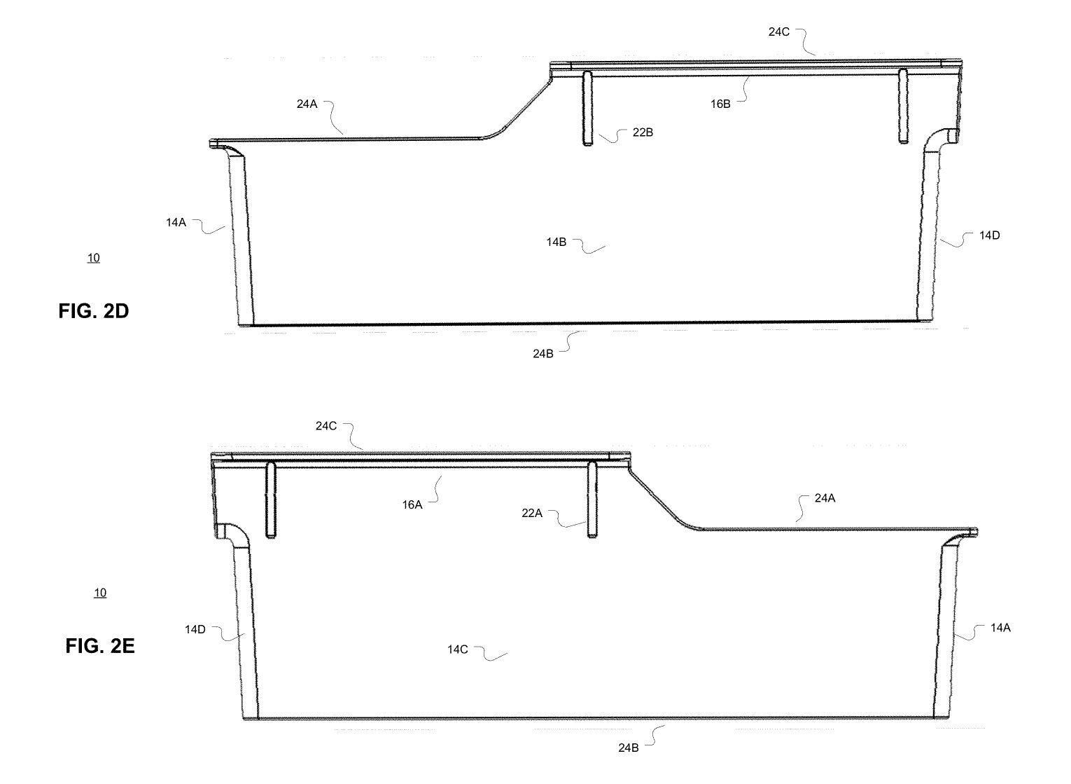

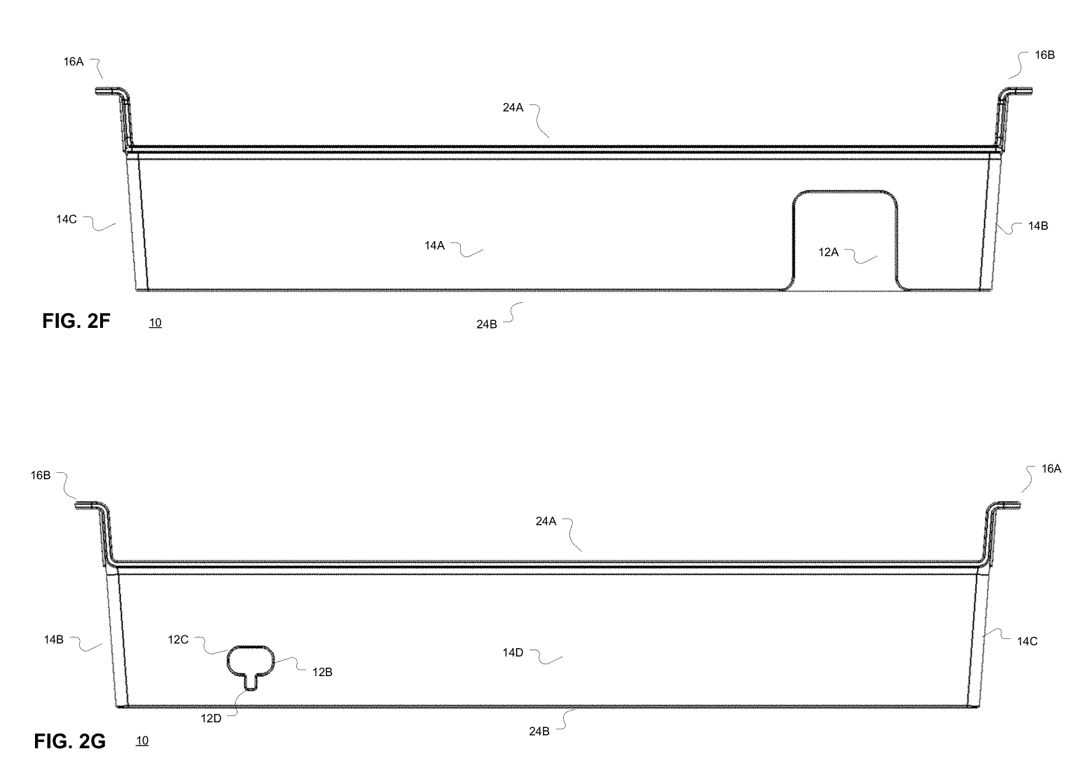

FIG. 2A is a simplified isometric diagram of an open space organizer (OSO) system 10 in accordance with an embodiment of the present invention. FIG. 2B is a simplified top view diagram of an open space organizer (OSO) 10 system in accordance with an embodiment of the present invention. FIG. 2C is a simplified bottom view diagram of an open space organizer (OSO) system 10 in accordance with an embodiment of the present invention. As shown in FIGS. 2A, 2B, and 2C, an OSO system 10 may include a front wall 14A, a right wall 14B, a left wall 14C, and a rear wall 14D as a function of the shape of the open storage area 104 opening 104A section to interface (or organize). The OSO system 10 width (from front wall 14A to back wall 14D) and length (from right wall 14B to left wall 14C) may be selected as a function of the shape and size of the open storage area 104 opening 104A section to interface (or organize) including its border or frame 104B if any.

As also shown in FIGS. 2A-2C, the left wall 14C may have a left extension 16A and the right wall 14B may have a right extension 16B. The extensions 16A and 16B may be sized to engage an open storage area 104 central opening 104A border or frame 104B when engaged or deployed therein to prevent the OSO system 10 from engaging the open storage area 104 bottom 104C in an embodiment. In another embodiment, the OSO system 10 bottom side 24B may engage the open storage area 104 bottom 104C when engaged or deployed therein. In an embodiment, the OSO system 10 may be about 125 to 300 mm in length and about 200 mm in an embodiment (from back wall 14D to front wall 14A) and about 150 to 450 mm in width and about 302 mm in an embodiment (from the right wall 14B to the left wall 14C).

As also shown in FIGS. 2A-2C, the OSO system 10 may include several cavities, sections, or chambers 18A, 18B, 18C, and 18D. In an embodiment, the sections 18A-D may have different sizes, shapes, depths, and inclinations to support different items. In an embodiment, the section 18A may be inclined from the back wall 14D to the front wall 14A and sized to fit a cellular telephone or similar device. The angle of inclination may be about 10 to 30 degrees and about 15 degrees in an embodiment. In an embodiment, the section 18A may be about 120 to 240 mm in length and about 185 mm in an embodiment (from back wall 14D to front wall 14A) and about 60 to 120 mm in width and about 93 mm in an embodiment (from right wall 14B to sections 18B and 18D). As shown in FIG. 3B, the open storage area 104 may include a power outlet 104D including a USB, standard AC, 12 volt, or other power source interface. As shown in FIG. 2A, the front wall 14A may include an opening 12A that may be sized and located to enable a mating receptacle to engage the power outlet 104D. The section 18A may include an opening 12B in the back wall 14D to enable a connector for an electronic device to pass through and engage a wire to hold the connector a set distance from the back wall 14D.

In an embodiment, the section 18B may be rectangular in shape with a width (from left to right) of about 60 to 140 mm and about 92 mm in an embodiment and a length (from front to back) of about 70 to 150 mm and about 106 mm in an embodiment. The section 18B may have a depth less than the height of the OSO 10 from bottom side 24B to top side(s) 24A, 24C. In an embodiment, the section 18B depth may be about 10 mm to 40 mm and about 25 mm in an embodiment. The section 18B may be sized to hold a wallet or other item that a User may want to easily access.

In an embodiment, the section 18C may be similar to section 18B but have a greater depth. Section 18C may be rectangular in shape with a width (from left to right) of about 60 to 140 mm and about 93 mm in an embodiment and a length (from front to back) of about 70 to 150 mm and about 106 mm in an embodiment. The section 18C may have a depth about the height of the OSO 10 from bottom side 24B to top side(s) 24A, 24C. In an embodiment, the section 18C depth may be about 30 mm to 100 mm and about 48 mm in an embodiment. The section 18C may be sized to hold items that a User may want to securely store.

In an embodiment, the section 18D may have a similar depth to section 18C but have a greater width (left to right) but smaller length (front to back). Section 18D may be rectangular in shape with a width (from left to right) of about 100 to 300 mm and about 195 mm in an embodiment and a length (from front to back) of about 30 to 130 mm and about 70 mm in an embodiment. The section 18D may have a depth about the height of the OSO 10 from bottom side 24B to top side(s) 24A, 24C. In an embodiment, the section 18D depth may be about 30 mm to 100 mm and about 48 mm in an embodiment. The section 18D may be sized to hold longer items that a User may want to securely store.

FIG. 2D is a simplified right side view diagram of an open space organizer (OSO) system 10 in accordance with an embodiment of the present invention. FIG. 2E is a simplified left side view diagram of an open space organizer (OSO) system 10 in accordance with an embodiment of the present invention. As shown in FIGS. 2D and 2E the right wall 14B may include one or more flanges 22B that protrude beyond the right wall 14B to engage a wall of the inner cavity 104E of an open space area 104. The left wall 14C may include one or more flanges 22C that protrude beyond the left wall 14C to engage another, opposite wall of the inner cavity 104E of an open space area 104. In an embodiment, the OSO system 10 may be about 40 to 300 mm in depth and about 70 mm in an embodiment (from bottom side 24B to upper, top side 24C) and may be about 30 to 280 mm in depth and about 50 mm in an embodiment (from bottom side 24B to lower, top side 24A).

As also shown in FIGS. 2D and 2E, the front wall 14A and back wall 14D may be sloped inwardly from the top sides 24A, 24C to the bottom side 24B. The slope may be about 2 to 10 degrees and about 6 degrees in an embodiment. The slope may enable the front wall 14A and back wall 14D to engage a segment of the open storage area 104 inner cavity 104E in an embodiment to provide more secure placement of the OSO system 10 in an open storage area 104.

FIG. 2F is a simplified front side 14A view diagram of an open space organizer (OSO) system 10 in accordance with an embodiment of the present invention. FIG. 2G is a simplified back side 14D view diagram of an open space organizer (OSO) system 10 in accordance with an embodiment of the present invention. As shown in FIGS. 2F and 2G the front wall 14A may include a power interface opening 12A. The back wall 14D may include a power cable and electronic device power coupler opening 12B.

In an embodiment, the OSO system 10 power interface opening 12A may be squared shaped with each size about 10 to 60 mm in length and about 35 mm in an embodiment as a function for the size of the front wall 14A. In an embodiment, the OSO system 10 power cable and electronic device power coupler opening 12B may be include two coupled sections—one larger section 12C sized to enable an electronic device power coupler to pass therethrough and an offset smaller section 12D sized to engage a cable coupled to the electronic device power coupler. The larger section 12C may be shaped according to the electronic power coupler dimensions, e.g., larger than a USB, Apple device, or other type connector in an embodiment. Similarly, the wire opening section 12D may be sized for a wire size or diameter that is coupled to the electronic power coupler and may be slightly smaller than the wire diameter to enable a User to secure a cable within the wiring opening section 12D.

For example, in an embodiment, the larger opening 12C may be elliptical or rectangular in shape with a width of about 5 to 25 mm and about 15 mm in an embodiment and a height of about 3 to 15 mm and about 9 mm in an embodiment. Similarly, the offset smaller opening 12D may also be elliptical or rectangular in shape (but transverse to the larger opening 12C) with a width of about 1 to 5 mm and about 3 mm in an embodiment and a height of about 3 to 10 mm and about 5 mm in an embodiment. As also shown in FIGS. 2F and 2G, the right wall 14B and left wall 14C may be sloped inwardly from the top sides 24A, 24C to the bottom side 24B. The slope may be about 2 to 10 degrees and about 6 degrees in an embodiment. The slope may enable the right wall 14B and left wall 14C to engage a segment of the open storage area 104 inner cavity 104E in an embodiment to provide more secure placement of the OSO system 10 in an open storage area 104.

While this invention has been described in terms of a best mode for achieving the objectives of the invention, it will be appreciated by those skilled in the art that variations may be accomplished in view of these teachings without deviating from the spirit or scope of the present invention. In an embodiment, the sections 18A-D may include non-slip inserts. The OSO system 10 may be formed of various materials including metals, alloys, polymers, wood, and composites of man-made and natural materials. In an embodiment, the OSO system 10 may formed of Acrylonitrile butadiene styrene or other thermoplastics via injection molding. In an embodiment, the OSO system 10 may employed in a motorized vehicle including a car, SUV, and truck. In an embodiment, the OSO system 10 may configured to be employed in a 2007-2018 Toyota Tundra or 2008-2018 Toyota Sequoia's center console.

What is claimed is:

1. An open space area organizer, the open space having a shaped opening and a depth, including:
a plurality of walls forming a complementary shape to the open space's shaped opening, the complementary shape having a top and a bottom;
a plurality of sections formed within the plurality of walls; and
one of the plurality of sections inclined at an angle and sized to accommodate an electronic device.

2. The open space area organizer according to claim 1, wherein inclined section includes a power coupler opening in one of the plurality of walls.

3. The open space area organizer according to claim 1, wherein the inclined section includes a power coupler opening with an offset cable opening in one of the plurality of walls.

4. The open space area organizer according to claim 2, wherein the open space includes a power outlet in its opens space and one of the plurality of walls includes a power outlet opening sized to enable access to open space area organizer power outlet.

5. The open space area organizer according to claim 2, wherein the open space includes a power outlet in its opens space and one of the plurality of walls forming the inclined section includes a power outlet opening sized to enable access to open space area organizer power outlet.

6. The open space area organizer according to claim 1, wherein one of the plurality of walls is inclined inwardly from the complementary shape top to bottom.

7. The open space area organizer according to claim 1, wherein all of the plurality of walls are inclined inwardly from the complementary shape top to bottom.

8. The open space area organizer according to claim 1, wherein the open space includes a border at its shaped opening and one of the plurality of walls includes an extension sized to engage a portion of the border to control the depth of insertion of the open space area organizer within the open space.

9. The open space area organizer according to claim 1, wherein the open space includes a border at its shaped opening and two of the plurality of walls include an extension sized to engage a portion of the border to control the depth of insertion of the open space area organizer within the open space.

10. The open space area organizer according to claim 1, wherein the plurality of sections formed within the plurality of walls includes at least two other sections and one of the at least two other sections has a depth less than the other of the at least two other sections.

11. An open space area organizer, the open space having a rectangularly shaped opening and a depth, including:
four walls including a front wall opposite a back wall and a left wall opposite a right wall, the left wall and right wall transverse to the front wall and back wall, the four walls forming a complementary rectangular shape to the open space's rectangularly shaped opening, the complementary rectangular shape having a top and a bottom;
a plurality of sections formed within the four walls; and
one of the plurality of sections inclined at an angle and sized to accommodate an electronic device.

12. The open space area organizer according to claim 11, wherein inclined section is bordered by the right, back, and front walls, inclined upwardly from the back wall to the front wall, and includes a power coupler opening in the back wall.

13. The open space area organizer according to claim 11, wherein the inclined section includes a power coupler opening with an offset cable opening in the back wall.

14. The open space area organizer according to claim 12, wherein the open space includes a power outlet in its opens space and the front wall includes a power outlet opening sized to enable access to open space area organizer power outlet.

15. The open space area organizer according to claim 12, wherein the open space includes a power outlet in its opens space and one of the back, front, and right walls includes a power outlet opening sized to enable access to open space area organizer power outlet.

16. The open space area organizer according to claim 11, wherein the left and the right wall are inclined inwardly from the complementary rectangular shape top to bottom.

17. The open space area organizer according to claim 16, wherein the front and the back wall are inclined inwardly from the complementary rectangular shape top to bottom.

18. The open space area organizer according to claim 11, wherein the open space includes a border at its shaped opening and one of the left wall and the right wall includes an extension sized to engage a portion of the border to control the depth of insertion of the open space area organizer within the open space.

19. The open space area organizer according to claim 11, wherein the open space includes a border at its shaped opening and the left wall and the right wall include an extension sized to engage a portion of the border to control the depth of insertion of the open space area organizer within the open space.

20. The open space area organizer according to claim 11, wherein the plurality of sections formed within the four walls includes at least two other sections and one of the at least two other sections has a depth less than the other of the at least two other sections and the at least two other sections are bordered by the left wall.
